(19) United States
(12) Patent Application Publication
(10) Pub. No.: US 2002/0120410 A1
(43) Pub. Date: Aug. 29, 2002

(54) Apparatus and method for analyzing liquid absorbency/desorbency, pore volume distribution and in-plane wicking/absorption

(76) Inventor: Behnam Pourdeyhimi, Cary, NC (US)

Correspondence Address: JENKINS & WILSON, PA, 3100 TOWER BLVD, SUITE 1400, DURHAM, NC, 27707, US

(21) Appl. No.: 09/995,389

(22) Filed: Nov. 27, 2001

Related U.S. Application Data
(60) Provisional application No. 60/253,716, filed on Nov. 28, 2000.

(51) Int. Cl. G06F 19/00; G01N 31/00

(52) U.S. Cl. 702/30

(57) ABSTRACT

An improved apparatus and method for characterizing in-plane liquid transport, liquid absorbency, liquid desorbency and pore volume distribution of liquid in a textile, paper or similar material test sample. A camera is used for recording images of the fluid on the material sample, and the recorded images are then analyzed with a computer in order to make real time determinations of selected properties of in-plane liquid transport, liquid absorbency and/or desorbency and pore volume distribution in the material sample. Also, an improved test plate is provided for use with the improved apparatus and method.

### RELATED APPLICATION

This application is a conventional application claiming the benefit of the priority date of U.S. Provisional Application Serial No. 60/253,716 filed Nov. 28, 2000.

### FIELD OF THE INVENTION

The present invention relates to the field of measurement of absorbency of textile, paper and other similar materials. More particularly, the present invention relates to an apparatus and method which enables in-plane liquid spread and recording of the liquid spread to occur simultaneously to facilitate selected measurements of absorbency, desorbency and/or pore volume distribution of liquid in a textile, paper or other similar material.

### RELATED ART

Nonwovens are textile assemblies made up of fibers that are neither interlaced nor interlocked, but instead they are held together through mechanical, thermal or chemical bonding. It is this unique way of producing the materials that results in the materials being highly anisotropic. Nonwovens are highly anisotropic materials and unlike woven and knitted fabrics where the properties of the material depend greatly on the way in which the yarns are interlaced or interlooped, a nonwoven's properties depend greatly on the way in which the fibers are oriented within the material which can vary significantly from one product to another depending on the production techniques and any further processing that the product might experience.

The anisotropy of a nonwoven is an important structural characteristic of the material because it allows the user to isolate the directional properties of the nonwoven and due to this the structure can be engineered such that the materials serves a specific purpose. It has been found that important structural characteristics such as the tensile strength and the bending rigidity are directly influenced by the anisotropy of the nonwoven. There are other important properties of nonwovens that have not been correlated with the structural anisotropy. This includes the liquid distribution of the material.

Nonwovens are used in such products as baby diapers, feminine products, geotextiles, medical equipment such as gowns and sterilization covers, and may someday be a common method for the production of clothing. In most of these areas one of the key properties of the material is its liquid transport ability and more specifically the in-plane liquid distribution. In-plane liquid distribution is the movement of liquid within the plane of the fabric as opposed to the movement of liquid perpendicular to the plane of the fabric, which is referred to as transplanar distribution. The in-plane liquid distribution is used to distribute liquid over a given area so that either total evaporation of the liquid can occur more readily, such in the case of perspiration on clothing, or so that the product can be used to its maximum capacity, such in the case of the second layer of a baby diaper. If the connection between the anisotropy and the liquid distribution can be made then the liquid flow can be modeled as a function of the anisotropy and from there the nonwoven materials can be made such that the liquid distribution is engineered to meet a specific purpose. It is necessary, however, to first measure the intrinsic in-plane liquid distribution of the material.

Presently there are many different ways in which liquid movement within the nonwoven is measured. These are normally divided into two categories: liquid absorption from a limited reservoir and liquid absorption from an unlimited reservoir. The drop test is an example of a test from a limited reservoir. The invention described and claimed hereinbelow, however, focuses on absorption from an unlimited reservoir because for many of the nonwoven applications the liquid that wets the material can be assumed to constitute an unlimited reservoir. Conventionally tests that have been used to measure liquid absorption from an unlimited reservoir are tests such as the vertical wicking test, the dunk test, and the Gravimetric Absorbency Test System (GATS). The results from these tests, however, are all inconclusive because of the way in which the tests are carried out. To resolve these problems a new system has been developed.

The new instrument and method described and claimed hereinbelow is based on the GATS testing system and has been developed in order to measure and quantify the in-plane liquid distribution of nonwoven fabrics as well as absorbency, desorbency and pore size distribution. This system is able to accurately calculate the liquid distribution with the added feature of a camera mounted above the testing plate. A new test plate has also been developed so that the intrinsic liquid absorption rate can be better determined. The new plate is a flat circular plate that is hollowed out. The material that is placed on the plate touches the plate only in the center where the liquid is distributed to the fabric and around the edges for support. Unlike the old testing plates the new plate adds no new capillaries to the system and therefore allows for the true intrinsic wicking of the material to be generated. With the new plate and the new machine the effect of fabric anisotropy on liquid distribution can easily be determined.

### Conventional Test Methods and Appartuses for Liquid Absorption/Wicking

As noted above, there are many tests that are presently used for measuring the absorption rate of a material. These tests include the vertical wicking test, downward wicking test, the basket test, GATS test and more recently the NCRC (Nonwovens Cooperative Research Center) directional absorbency test. Strip tests are generally used to measure absorption in a given direction while the other tests, basket, GATS, and the NCRC directional absorbency test, are used to measure the bulk of liquid uptake into a system whether that is transplanar or in-plane liquid uptake. Although there are arguments to use the previously mentioned tests, they all possess inherent problems and shortcomings well known to one skilled in the art. The test methods and the problems associated with each one are discussed below.

The vertical wicking test, as the name implies, is an absorbency/wicking test carried out with the specimen being tested vertically. This is referenced in the Association of Nonwoven Fabrics Industry (INDA) standard test method 10.1. For this test, a strip of material is cut in a given direction (usually the machine or cross direction) and one end of the material is suspended while the other end hangs vertically down into a liquid reservoir. The test fabric is preconditioned at 20°C. and 65% RH. The time it takes for the liquid to rise to a given height is timed. There are different standards for those materials that are considered to wick slowly and those that are considered to wick at a rapid rate. For the slow ones the time allotted is 24 hours and the ones that wick fast are allotted five minutes maximum.

Many people include an additional piece of equipment during testing that measures the change in weight of the material as the liquid is absorbed into the system. Although this is not included in the standard test method it is often a useful technique of measuring liquid absorption. The material can be hung from a device in which the weight of the material during uptake is recorded. This is a direct measurement of the amount of liquid being absorbed into the material. When the material is fully saturated, the weight balance will show a constant value and the test is ended.

As stated hereinbefore, other tests for measuring wicking and/or absorption are the basket test, the Gravimetric Absorbency Testing System (GATS), and more recently the NCRC directional wicking test.

The basket or sink test as it is sometimes referred to, is used to measure the total liquid uptake into a material over a period of time. This is also referenced in the Association of Nonwoven Fabrics Industry (INDA) standard test method 10.1. This test is executed by cutting out a strip of material weighing 5 grams and then rolling it up and placing it into a basket. The basket is then placed into a liquid reservoir and the time it takes for the material to sink is recorded. When the basket is recovered from the liquid the excess liquid is allowed to drain off and then the weight of the material is measured by subtracting from the total weight the weight of the basket. There are a number of problems associated with this test method, which may make the test unsuitable for real world applications. First, the rolled up material forms extra capillaries between its layers. These capillaries have the potential of holding liquid and thus the reading for the weight may be a greater than the actual amount of liquid that the material could absorb for a given period of time. Second, the absorption rate cannot be modeled by using this test procedure.

Another way to measure absorption versus time is the conventional GATS machine available from M/K Systems, Inc. of Danvers, Massachusetts (see FIGS. 1-2). The Gravimetric Absorbency Testing System or GATS 10 is a system for measuring the wicking rate of a material over a period of time. It consists of a liquid reservoir 12 that is connected to a platform or test plate via a plastic tube 14. The plastic tube enters the test plate 16 from the bottom and this is how the liquid is delivered to the material. The liquid reservoir rests on top of a balance 18, which is connected to a computer 20. The material, a circular piece of fabric, is placed on the platform 16 and the test is initiated by using an automatic start switch. The material then begins to absorb the liquid delivered to it through the plastic tube 14. As the liquid in the reservoir 12 drops the value on the balance 18 also drops and this is recorded by the computer 20 as the amount of liquid absorbed by the material per unit time.

More specifically, the GATS consists of a base unit incorporating the electronics on which is mounted a solenoid assembly and 3-way valve 22, lead screw slide assembly with sample test plate 16, and electronic balance (EB 18). On the balance is mounted a fluid feed system consisting of a two chamber reservoir 12 which rests on a frame surrounding the pan of the EB. The reservoir top chamber 12A holds sufficient fluid (water or any other fluid) for several tests and has a cover with a hole for filling. The bottom chamber 12B holds the refill solenoid assembly 22 and the fluid cell 24. The cell holds a specific weight of fluid automatically siphoned to the test sample during a test. A plexiglas rod 26, screwed into the base of the fluid cell and topped by a sample weigh platform 28, allows separate use of the balance. A wind cover 30 is provided to cover this pan during operation. The same rod, without the weigh platform is used to lift the fluid cell off the balance during set-up for testing. The test sample rests on test plate 16 which is connected to the fluid cell 24 by means of the silicone tubing 14, the 3-way valve 22 and the glass siphon tube. The test plate 16 is connected to the lead screw slide assembly 32 which makes it possible to match the level of the fluid in test plate to that of the cell. During a test, a stepper motor 34 automatically lowers the test plate 16 at the same rate as the fluid is absorbed so that the present head level is maintained on the sample throughout the test.

GATS employs one of two possible plates for which the sample rests. First, there is a plate 16A with a small hole 16A′ in the center (see FIG. 4) referred to as the point absorbency test. This test is used to measure in-plane absorbency/wicking over a period of time. In this test, the liquid is absorbed only from the small hole and then is allowed to spread over the entire area of the material. The test is stopped either after a given period of time or when the sample is fully saturated. The sample is considered to have reached full saturation when there is no notable difference in the change of the liquid in the reservoir indicated by no change on the balance.

Another plate utilized for this test is the “porous” plate 16B. (see FIG. 5) The sample that is placed on this plate absorbs liquid over the entire surface of the material is used to measure the total absorbency of the sample. This is widely used for thicker samples where transplanar wicking as well as in-plane wicking is occurring or when total absorbency is to be determined.

There are inherent problems with the GATS test method and apparatus that are well known. First, an extra capillary may form between the plate and the material, especially when using the point test plate. This may result in faster absorption times than would normally be associated with the intrinsic wicking ability of the material. Second, the directionality of the wicking cannot be isolated. This means that although the total absorption of the material can be measured, the rate of wicking in a given direction is not known. The Nonwoven Cooperative Research Center in Raleigh, North Carolina (NCRC) developed a plate that would enable the directionality of the liquid spread to potentially be isolated. The test method that NCRC developed utilizes the conventional GATS equipment, but uses a plate 16C that is rectangular in shape (see FIG. 6) and measures the liquid spread of a strip of material cut in a given direction (such as the cross or machine direction).

This test is similar to the vertical and downward wicking test except that the test is executed in a horizontal position. The material is only in contact with the plate in the center and along the edges. This eliminates the extra capillaries formed between the plate and the fabric. One of the problems that arise with this test is overflow of the liquid into the trough of the plate. This in turn results in inconclusive results because the data that is being recorded is not only a function of the liquid being absorbed by the material, but also a function of the liquid that is filling the trough. Also, like the vertical wicking test there are edge effects.

A solution to the shortcomings of the conventional test methods and apparatuses is described and claimed below.

### DISCLOSURE OF THE INVENTION

The present invention provides a method for testing predetermined absorbency characteristics of a textile, paper or similar material sample including the steps of: (1) providing a liquid reservoir mounted on an electronic balance or load cell; (2) providing a vertically movable test plate for the material sample and a liquid conduit between the liquid reservoir and the test plate; and (3) analyzing liquid absorbency and/or desorbency with a computer operatively connected to the electronic balance or load cell. The improvement provided by the invention comprises (a) recording images of the liquid on the material sample with a camera mounted above the test plate and operatively connected to the computer; and (b) analyzing the recorded images with the computer to make real time determinations of selected properties of liquid absorbency and/or desorbency of the material sample.

Also, the invention provides for an apparatus for testing absorbency characteristics of a textile, paper or similar material sample comprising: (1) a liquid reservoir mounted on an electronic balance or load cell; (2) a liquid supply system for supplying a plurality of test liquid samples from a storage chamber in the liquid reservoir to a test liquid chamber; (3) a vertically moveable test plate and actuator assembly for mounting of the material sample thereon; (4) a liquid conduit extending from the test liquid chamber to the test plate; and (5) a computer operatively connected to the electronic balance or load cell. The invention provides for the improvement comprising a video camera mounted above and at a predetermined distance from the test plate and adapted to be vertically moveable therewith, the video camera being operatively connected to the computer; and a computer program for analyzing recorded images from the video camera to make real time calculations of liquid absorbency and/or desorbency characteristics of the material sample.

It is therefore an object of the present invention to provide an improved method and apparatus for measuring absorbency, desorbency, and pore volume distribution of liquid within a textile, paper or other similar sample material.

It is another object of the present invention to provide a method and apparatus for making an orientation distribution function (ODF) of fluid absorbency and/or desorbency of a textile, paper or similar test material as well as pore volume distribution measurements.

It is still another object of the present invention to provide a method and apparatus for measuring in-plane liquid distribution in a textile, paper or similar test sample and simultaneously video recording spread of the liquid distribution.

It is still another object of the present invention to provide an improved sample test plate for use in the apparatus and method of the present invention.

Some of the objects of the invention having been stated hereinabove, other objects will become evident as the description proceeds when taken in connection with the accompanying drawings as best described hereinbelow.

### BRIEF DESCRIPTION OF THE DRAWINGS

FIG. 1 is a schematic drawing of a prior art gravimetric absorbency testing system (GATS) apparatus;

FIG. 2 is a front elevation view of the GATS apparatus shown in FIG. 1;

FIG. 3 is a front elevation view of the GATS apparatus modified in accordance with the present invention;

FIG. 4 is a perspective view of a prior art point absorbency test plate which is used with the prior art GATS machine shown in FIGS. 1 and 2;

FIG. 5 is a perspective view of a prior art porous test plate which is used with the conventional GATS apparatus shown in FIGS. 1 and 2;

FIG. 6 is a perspective view of a rectangular disk plate used with the conventional GATS apparatus shown in FIGS. 1 and 2;

FIG. 7 is a perspective view of the novel hoop plate used in combination with the modified GATS apparatus of the present invention;

FIG. 8 is a perspective view of the hoop that may be optionally used on the hoop plate shown in FIG. 7; and

FIGS. 9A-9C represent typical liquid spread images that are captured during liquid spreading by the modified GATS apparatus and method of the present invention.

### DETAILED DESCRIPTION OF THE INVENTION

### Antisotropic Fabric

Anisotropy is a measure by which one can characterize the directional variation of material. An isotropic material would exhibit equal in-plane liquid distribution about all angles or bins. Anisotropic material would show a strong directional dependence about a particular angular range or about multiple angular ranges while exhibiting minimum values about other ranges. A polar plot shows the in-plane liquid distribution of an anisotropic material. The anisotropy can be expressed as the ratio of the maximum radius to minimum radius of the ellipse. An isotropic material would show a circular distribution. One can use the Cos² Anisotropy ratio to express the anisotropy. The Cos² anisotropy parameter fₚ can be defined, with the help of the liquid distribution function. For simplicity, this can be referred to as the Orientation Distribution Function (ODF) since the liquid distribution is dominated by the orientation distribution of the fabric.

fₚ varies between −1 and 1.

1 indicates a perfect alignment parallel to the reference direction

−1 indicates a perfect perpendicular alignment to that direction

fₚ is zero for a random assembly—isotropic behavior

$${f}_{p} = 2 [ \frac{{\int }_{0}^{π} ψ ( θ ) {cos}^{2} ( {θ}_{ref} - {θ}_{i} ) ⅆ θ}{{\int }_{0}^{π} ψ ( θ ) ⅆ θ} ] - 1$$

### Orientation Distribution Function (ODF)

The comparison of a fabric's anisotropy to the anisotropy of the liquid distribution requires that the orientation distribution function (ODF) of the fabric be determined. The ODF is determined by first digitizing an image of the fabric. Then, a median filter was applied to the image to eliminate high frequency noise and a Fast Fourier Transform (FFT) procedure was used to determine the ODF.

A nonwoven is considered to a highly anisotropic material. To study the fabric's anisotropy, the orientation distribution function (ODF) was measured. The ODF Ψ is a function of the angle θ. The integral of the function Ψ from an angle θ₁ and θ₂ is equal to the probability that a fiber will lie between the angles θ₁ and θ₂(48). The function V must additionally satisfy the following conditions:

Ψ((θ+π)=Ψ(θ)

$${\int }_{0}^{π} ψ ( θ ) ⅆ θ = 1$$

It can easily be seen from the above definition that the ODF is dependent on the anisotropy of the material. To determine a material's dominant orientation angle the following formula is used:

$$\overline{θ} = \frac{1}{2} {tan}^{- 1} \frac{{\sum }_{i = 1}^{N} f ( {θ}_{i} ) sin 2 {θ}_{i}}{{\sum }_{i = 1}^{N} f ( {θ}_{i} ) cos 2 {θ}_{i}}$$

and the standard deviation is given as:

$$σ ( θ ) = {[ \frac{1}{2 N} {\sum }_{i = 1}^{N} f ( {θ}_{i} ) ( 1 - cos 2 ( {θ}_{i} - \overline{θ} ) ) ]}^{1 / 2}$$

### Fast Fourier Transform

The ODF of digitized images was calculated using a Fast Fourier Transform (FFT) procedure. FFT is an indirect method of measuring the ODF, but has been shown to be very effective. A brief description of FFT is given below.

An image is represented by transitions in the gray scale from light to dark and dark to light. These transitions represent the fibers and the spaces between them. The rate of transition is related to the orientation of the fibers. The FFT performs the transform by processing all of the rows one at a time and then by doing the same for the columns. This results in a two-dimensional set of values each with its own magnitude and phase. The orientation of the fibers is related to the transform because changes in the horizontal gray scale encompass vertical elements and vice versa. The equation of the direct and indirect Fourier transforms in two dimensions is the following:

$$F ( u , v ) = {\int }_{- ∞}^{∞} {\int }_{- ∞}^{∞} f ( x , y ) exp [ - j 2 π ( ux + vy ) ] ⅆ x ⅆ y$$

$$f ( x , y ) = {\int }_{- ∞}^{∞} {\int }_{- ∞}^{∞} F ( u , v ) exp [ j 2 π ( ux + vy ) ] ⅆ u ⅆ v$$

where,

f(x y)=the image

F(u,v)=the image's transform

u=frequency along the x direction

v=frequency along the y direction

The transform's reference is in the center of the image and therefore the orientation can be directly found for an annulus of a given width w and radius r. A given width is necessary for the annulus because if only a point was examined instead of an area there would be too much noise in the results and for that reason the data is averaged over a given width. The image is scanned radially to determine the ODF and the average intensity is found for a specified angular range. The images that were scanned and which are shown in representative FIGS. 9A-9C can be examined in a ten-degree angular range.

There are problems with using only an FFT function for given images. The FFT assumes periodicity, which means that when the image is scanned horizontally or vertically the resulting function will be periodic. Unfortunately most images are not periodic due discrepancies at the edges of the image. These discrepancies are caused by the right edge of the image not matching perfectly with the left side of the image or the top of the image not matching perfectly with the bottom of the image.

To reduce the problem windowing is introduced. In windowing the FFT function is multiplied by a given function to alleviate edge discrepancies. The data from the FFT without windowing can have a great affect on the standard deviation of the ODF. The ODF's standard deviation is more accurate after windowing than the ODF's standard deviation before windowing. The standard deviation is still slightly overestimated.

### Pore Volume Distribution

The pore volume distribution can be measured with the following equation:

$$r = \frac{{2}_{γ} cos θ}{g \times p \times h}$$

p=density of liquid

g=gravity

y=liquid surface tension

θ=contact angle

r=pore radius

h=height

The pore size (e.g., pore volume) measurements are made by causing a ΔP to be exerted on the saturated sample. This is accomplished by moving the sample test platform up incrementally by predetermined height changes (using the software controlled stepper motor and screw). The largest pores will release liquid back to the reservoir until the pores at that particular size range have been evacuated.

One the balance readings have stabilized, the platform will be moved up once again to a pre-determined height. The liquid contained in the next respective size pores will be evacuated into the reservoir and the balance readings will be monitored for stabilization. The procedure is repeated automatically until the desired pore size information is obtained, the sample is completely evacuated, or the mechanical limitations of the riser sled is reached. (Pore size and pore volume are terms that are used interchangeably herein.)

### APPARATUS AND METHOD OF INVENTION

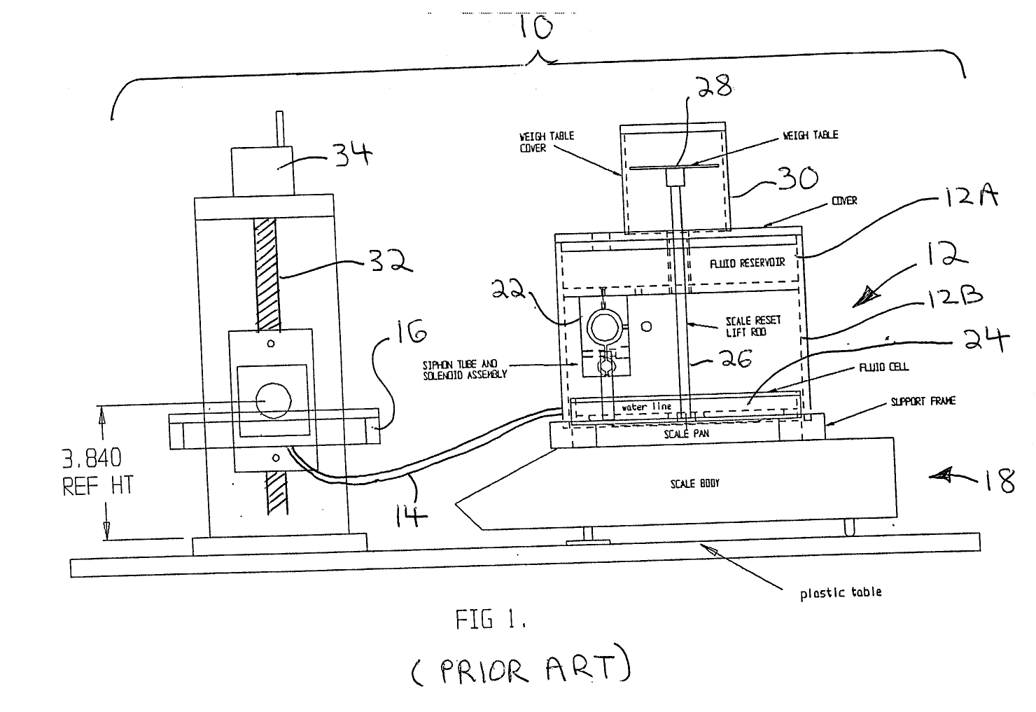

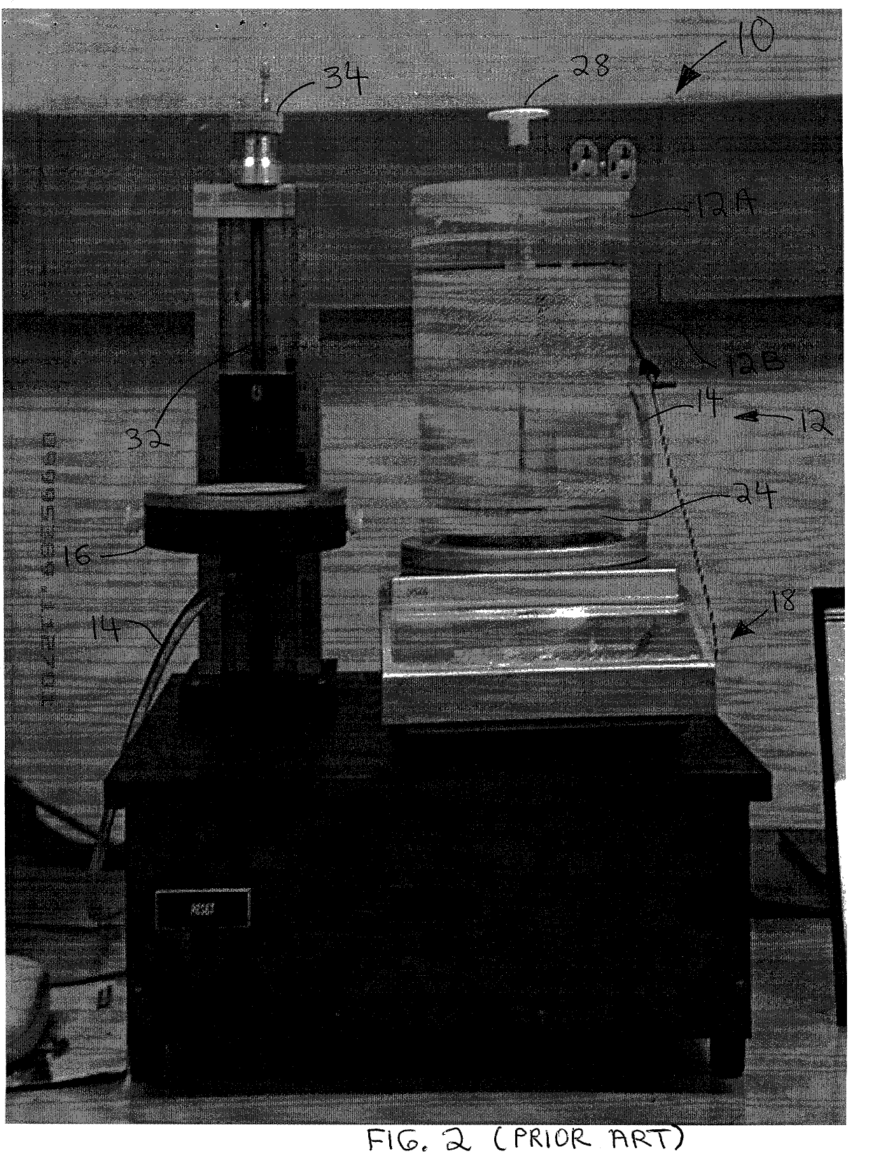

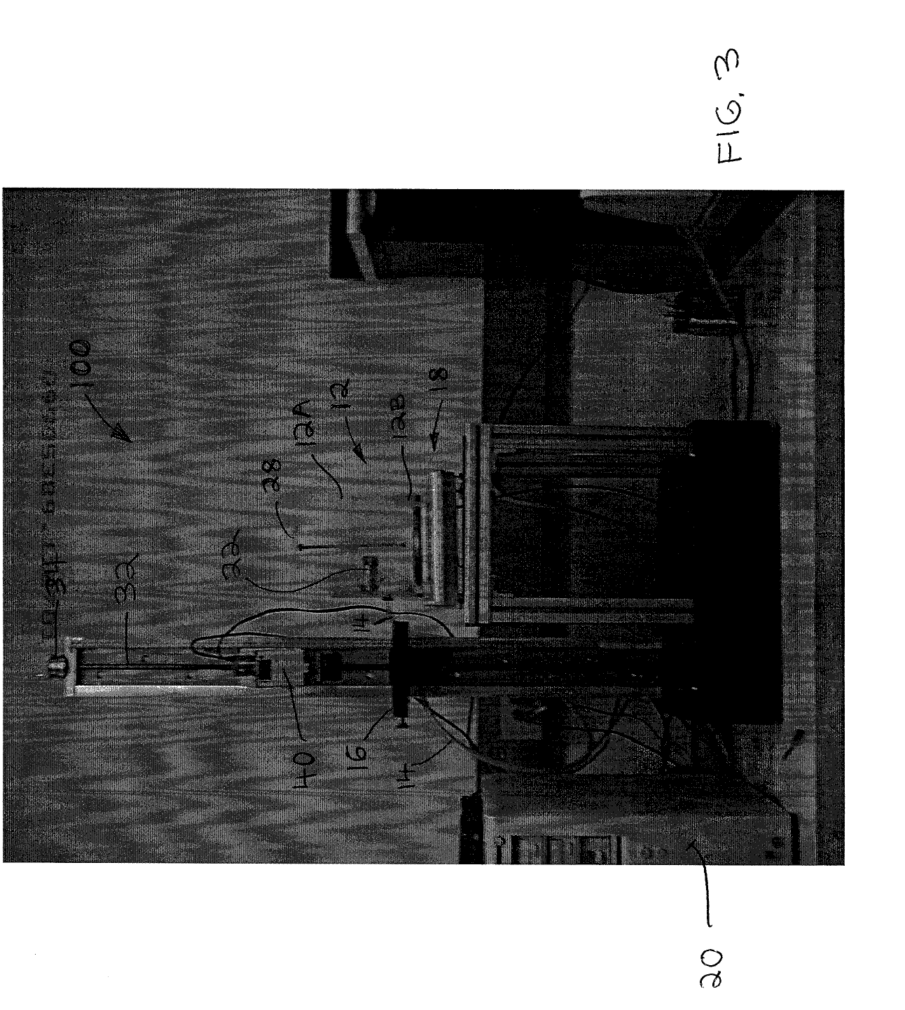

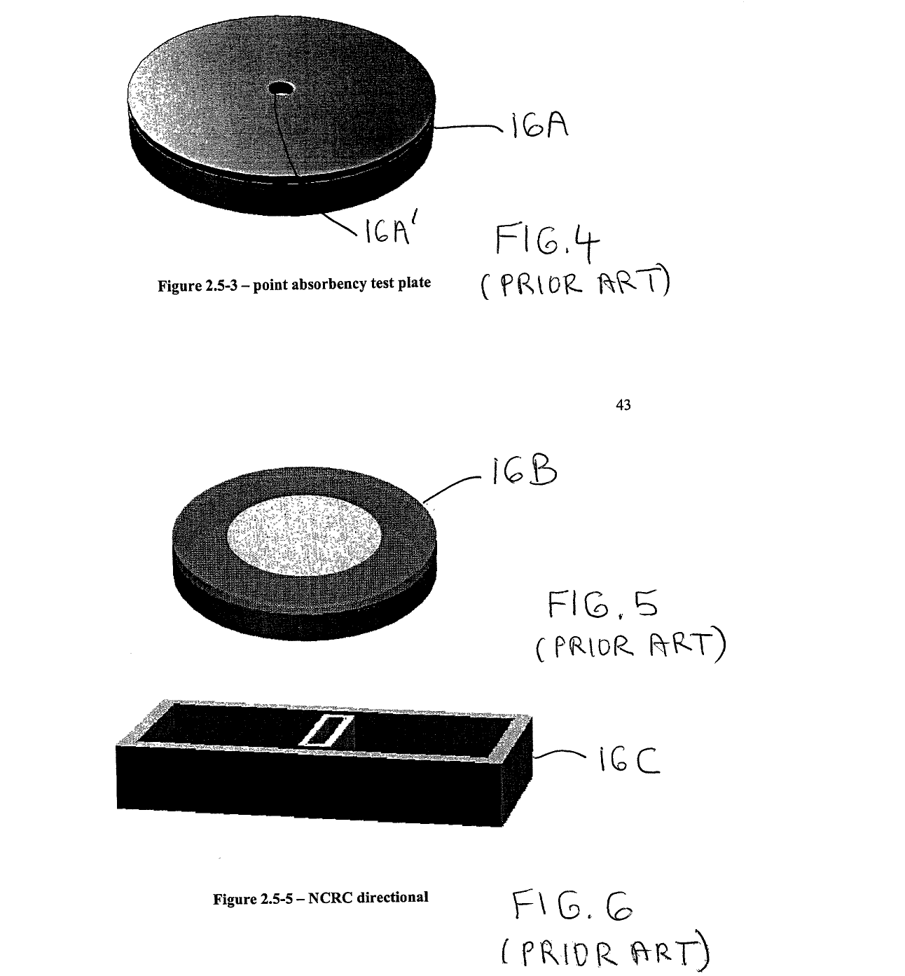

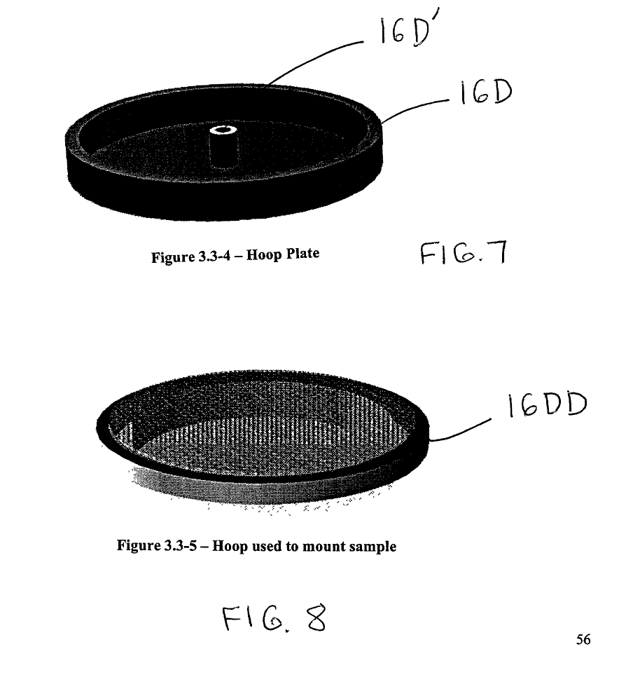

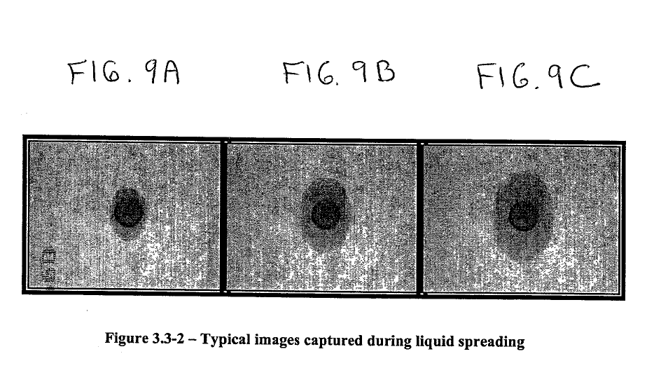

Given the preliminary description of a portion of applicant's methodology described above, it should be further understood that tests for this study were carried out on a modified GATS machine 100. This machine is shown in FIGS. 3 and 7-8 where like numerals indicate like elements in FIGS. 1 and 2. This instrument is set up with a liquid reservoir 12 that is placed on top of a balance 18 and is connected to the bottom of a plate 16 using a plastic tube 14. In addition to this configuration, a camera 40 is mounted above the plate 16 and is used to record the spreading of the liquid. Previously, when no camera is attached above the plate only the amount absorbed and not the direction in which it spreads can be determined.

FIGS. 9A-9C show typical images captured during the progression of the absorption test. These images are digitized at a present time interval. The images are then analyzed to determine the characteristics of the spread's properties such as anisotropy and area spread per unit time.

The modified instrument shown in FIGS. 3 and 7-8 also has the ability to move the platform 16 automatically during testing. This allows for a constant pressure or a change in pressure to be achieved throughout the test. For example, if a zero hydrostatic pressure head is desired the platform 16 will actually move down as liquid is absorbed so that the level of the liquid in the reservoir 12 and the level of the platform 16 are kept even. The platform is able to move because it employs a stepping motor 34 that drives the shaft 32 that the platform 16 is mounted on. The camera 40 that is mounted above the platform 16 is attached to the same platform and therefore moves with the platform. Moving the camera 40 with the platform 16 provides a constant distance and magnification.

Computer 20 is a PC and the electronic balance 18 is connected to the serial port of computer 20. Camera 40 is integrated through a PCI based frame grabber (not shown). The motor controls of modified GATS machine 100 are integrated with the computer 20 by a PCI based DIO card (not shown).

Modified Gats Apparatus

There are a number of problems associated with the synchronization of image digitization during moisture absorbency. To overcome these difficulties, special device 100 was built that integrates moisture transport monitoring as well as image capture. The instrument is composed of a moveable platform 16 onto which the sample is placed. The camera 40 is attached to the same platform. A liquid reservoir 12 sits on a sensitive balance 18. The reservoir is connected to the sample stage by a tube 14. The sample stage is kept level with the liquid level in the reservoir 12. The conventional sample stage 16A provides a single hole measuring 4 mm in diameter through which liquid may be absorbed (transported) by the fabric. Alternatively, conventional porous plate 16B may be used or the novel plates described hereafter. The size of the porous plate is 5 cm. This is the same as the specimen size used. When the liquid is absorbed by the sample, the liquid level in the reservoir 12 is reduced. To avoid the drainage of the liquid in the fabric back to the reservoir brought about by the pressure gradient caused by the differences in height, the sample platform 16 is moved automatically so as to keep it level with the liquid level in the reservoir 12. This is accomplished by a stepping a stepper motor 34 that drives the shaft 32 connected to the stage.

The stepper motor 34 requires pulses to be driven. These pulses are in the form of a square wave. The period of the square wave determines the speed with which the motor moves. The pulses can be sent to the motor 34 using commercially available controllers that communicate with the motor using serial ports. Serial port communication is often unreliable and therefore, applicant developed a new controller. For this a National Instrument multi-purpose interface card that has digital input/output (DIO was used). This interface card is used for driving the motor. Further, applicant prefers to replace the balance 18 with a compression load cell thereby improving the response time of the system. Through the DIO ports, a square wave with amplitude of 5 volts is sent to the motor via a power amplifier (not shown). The minimum resolution achievable is 1 millisecond. This means that 1000 pulses a second can be sent to the motor 34 stepping it by 500 steps (500 on and 500 off in a square wave). Stepper motors rotate by 1.80 with each step resulting in 200 steps per revolution. The speed of the movement of the platform 16 is a function of the thread spacing on the shaft and the number of steps per unit time.

The stepper motor 34 and shaft 32 combination used on the device 100 provides a resolution of 200 steps per mm. The camera 40 is mounted on the same shaft and moves with the sample stage so that the focus is not disturbed. Through a callback function, there is continuous communication with the motor and can the operator can inquire its position or stop it immediately in an emergency. The weight is sampled by checking the balance 18 through the serial port. A sampling rate of 5 Hz was achieved. The image digitization is accomplished using a Matrox Meteor II frame grabber (not shown). The images can be saved individually or in a movie film.

The modified GATS apparatus 100 allows the following tests to be performed using water or any other fluid:

Absorbency

Absorbency refers to the transport of liquid due to capillary pressure and/or due to liquid absorption. The liquid pick up is monitored and images can be stored to evaluate the anisotropy of liquid transport.

Desorbency

Desorbency refers to the loss of liquid under a given pressure. The liquid loss is monitored and images can be stored to evaluate the loss of liquid.

Pore Size

Pore volume (size) is measured by saturating the sample and then allowing it to drain under different pressures. At each pressure, certain size pores can be evacuated.

The modification to the GATS apparatus was accomplished with the following equipment:

| Equipment | Part Number | Manufacturer |
|---|---|---|
| PCI-6035E Data | Part # 778026-01 | National Instruments |
| Acquisition Board | | |
| Connector Cable | Part # 182482-01 | National Instruments |
| Connector Block | Part # 777145-01 | National Instruments |
| Velmex Slide and block | Part # MA4039Q1-S4 | Velmex, Inc. |
| (1M) | | |
| Stepper Motor | Part # 4-9826 | Velmex, Inc. |
| Adapter Bracket | Part # 3-764-MD | Velmex, Inc. |
| Matrox Meteor II Frame | | The Imaging Source |
| Grabber | | |
| Computer 8 mm Lens | Part # H612FIC | Royal Systems |
| Hitachi KP-160U | | Royal Systems |
| Stepper Motor Controller | | American Precision |
| | | Instruments |

### Conventional Specimen Stage

FIG. 4 shows one of the plates P used in testing the sample and carried by platform 16. This plate P was shown previously when discussing the GATS machine. This is the plate that was mentioned earlier as the point test plate and which will subsequently be referred to as the bottom plate. Two different methods of testing can be executed on this plate. In the first method a piece of material that is to be tested is placed on the plate and a thin ring is placed around the outer edge of the material to weigh it down. In the second method, which will subsequently be referred to as top and bottom plate, the piece of material is placed on the plate and another clear plate is placed on top of the material. The second plate is used to ensure complete contact with the plate and is commonly used in absorption testing. There are some inherent problems with these conventional test methods as described above. The problems with these methods arise because of the added capillaries that are formed when the relatively rough surfaces of the fabrics are placed on the platform and also when the extra plate is placed on top of the material. These one or two added capillaries can cause the data from tests to be skewed.

### New Specimen Stage

FIG. 7 shows the new specimen stage 16D used for the tests. FIG. 7 shows the plate is hollowed out in the middle. The plate is described as the “hoop” plate due to the use of a hoop that holds the fabric tightly when placed on the plate for testing. The cylinder 16D′ in the middle of the plate is where the liquid enters the system. This is the initial point of absorption/wicking and is also the only point at which the fabric is touching the plate during the test. The point of contact measures 2.0 cm in diameter. A weight can be placed on the sample at this point to ensure complete contact and no overflow of the liquid into the trough. Although the fabric is in contact with the plate around the outer edge this area of the fabric is not considered in testing and therefore, has no effect on the results.

FIG. 8 shows the hoop sample holder 16DD used to test. Fabric is slipped in between the inner ring and the outer ring and the inner ring is expanded to hold the fabric in place. A slight tension is placed on the material, but it is felt that this has no affect on the test results. This hoop is slightly larger in diameter than the plate so that the fabric rests in intimate contact with the center cylinder and outer edge of the plate.

### Liquid Spread Analysis

As mentioned earlier, the new device 100 based on the GATS machine incorporates a camera 40 into the testing process to capture the images as the liquid (water or any other fluid) is spreading in the material. These images are stored digitally and are later analyzed for their liquid spread properties using image analysis. The process for analyzing these images is more complex than the process for finding the ODF of the material as described hereinbefore. This process demands that a filter be applied, the image to be thresholded, and the boundaries to be isolated, tracked and then finally the center to be found. From this all the necessary elements of the spread can be found.

Thresholding

Thresholding, also referred to as segmentation, is the process by which a gray scale image is converted into a binary one. This step is necessary for tracking boundaries because a black and white image is needed to fully distinguish the object being measured from the background. Some examples of thresholding are edge thresholding, simple thresholding, and dual thresholding.

Edge thresholding is applied to images where the contrast between the image and its background is not sufficient enough to separate the two into groups. This is often used when individual fibers need to be separated from the background. For edge thresholding an edge detector is used to identify local changes in the intensity. A region of the image is considered to be an edge when there is an abrupt change in the intensity. If there is no abrupt change then the pixel is considered to be part of the background. For images with good contrast simple thresholding can be applied. Simple thresholding is a technique where the pixels are grouped into two classes and unlike the edge thresholding without the consideration of their neighbors. The threshold cut off has been predetermined and is usually the mean intensity. This method works best when the images are bimodal. If the contrast is not as high, but the images are not small objects dual thresholding may be used.

Dual thresholding is similar to simple thresholding in that it takes they gray levels and separates them into two groups. Unlike simple thresholding it does not use the mean intensity to differentiate between the two groups. Instead it selects a range, which, such as in this case, may be designated black, and then everything above and below that range would be white. Depending on the quality of the image either simple thresholding or dual thresholding is used to clean up the images.

Sometimes images can appear to have high contrast when actually they do not. In this case just applying a simple threshold would mean some of the data would be lost. To improve the results of simple thresholding the local contrast is often improved prior to thresholding. Once again depending on the quality of the picture many different techniques may be used to improve the quality of the image prior to thresholding.

Boundary Extraction & Tracking

Images are representation of objects, which in this case is liquid spread. All images can be represented by chain code. This is the key for tracking the boundary of the liquid spread.

The chain code is the relationship of the center pixel to all of the pixels that are connected to it. There are two definitions for connectivity, four connectivity and eight connectivity. Four connectivity considers a pixel to be touching the center pixel only if that pixel is immediately to the right, left, upwards or downward from the center pixel. Eight connectivity also includes the four pixels diagonal from the center pixel. For tracking, the boundaries eight connectivity should be used.

Each of the pixels surrounding the center pixel is assigned a number zero through seven. These numbers are used to represent the movement from the center pixel to another pixel in a given direction. For example if the next pixel in the boundary was directly to the right of the starting pixel this movement would be designated seven. This new pixel would now be considered the center pixel. Then if the boundary moved diagonally up and to the right this movement would be designated zero. Thus the chain code that represents both of these moves is 7,0.

As mentioned earlier, to track the boundaries the image must first be converted into a binary image. This is achieved though thresholding. Although not required, the black area represents liquid spread and the white area represents the background. The opposite can of course be used.

Boundaries can be extracted from the thresholded images by a morphological operation. From here the image is scanned from the bottom up until the first black pixel is reached. An arbitrary direction is chosen and then the boundary is tracked and then recorded using chain code. The gravitational center is then found and from this point the liquid spread properties are determined. The liquid spread properties, such as the area spread in a given direction of the dominate angle, are determined by starting at the center of the binary image and then calculating the distance from the center to the boundary in a given direction. The result from a given angle is actually an average of the angle and the angle plus 180 degrees.

### ANALYSIS OF DATA

### Chi-Square Test

The relationship between two sets of ODF distribution data can be determined by applying the Chi-Square test. The Chi Square test can be used to compare the ODFs of subsets in a sample set and it can also be used to compare the liquid spread anisotropy to the same sample's ODF so that a relationship might be established. The values obtained from the test are then correlated to a given probability found in a chi-square table which lists the chi-square values and their corresponding probabilities. The values for the probabilities range from zero, where the sets are not the same, to one, where the sets are exactly the same. The formula for the test is the following:

$${X}_{v}^{2} = {\sum }_{i = 1}^{n} \frac{{( {O}_{i} - {E}_{i} )}^{2}}{{E}_{i}}$$

Eᵢ is the expected value and Oᵢ is the observed value.

### Anisotropy Parameter

A simple anisotropy parameter can be defined as the following:

$$Machine / CrossAnisotropy = \frac{MachineFrequency ( overarange )}{CrossFrequency ( overarange )}$$

This equation is often used to described anisotropy, but is not accurate because it only considers the machine and cross directions. The basic equation for anisotropy shown above is only valid for liquid distributions that maintain a shape that is a perfect ellipse (meaning no rough edges or variance from the path that the radii describe) that is oriented in either the machine or cross direction. If the shape of the ellipse varies from its original path or is not ellipse at all the results from this equation will be an inaccurate description of the spread. For example, if the distribution is bi-modal, for example with dominant angles in both the machine and cross direction, the number calculated using the above equation would be one. This number would give the impression that the spread was circular, but in fact the spread is non-circular. Also the equation only determines what is happening at the global level while many changes in the material occur at the local level. For these reasons the cos² anisotropy should be utilized for this analysis.

The cos² anisotropy is used to compare the change in the anisotropy as a function of time. The value for the cosine anisotropy can be evaluated using the following equations.

$${f}_{p} = 2 ⟨ {cos}^{2} θ ⟩ - 1$$

$$⟨ {cos}^{2} θ ⟩ = \frac{{\int }_{0}^{π} ψ ( θ ) {cos}^{2} ( {θ}_{ref} - {θ}_{i} ) ⅆ θ}{{\int }_{0}^{π} ψ ( θ ) ⅆ θ}$$

Where Ψ is the orientation distribution function and the integration of Ψ between θ₁ and θ₂ is equal to the probability that a fiber will lie in that interval. The value for the cosine anisotropy varies between −1 and 1 with −1 in this case pertaining to perfect alignment in the machine direction and the value of 1 pertaining to a perfect alignment in the cross direction. A value of the zero always indicates a random distribution leading to an isotropic flow with a circular front.

It will be understood that various details of the invention may be changed without departing from the scope of the invention. Furthermore, the foregoing description is for the purpose of illustration only, and not for the purpose of limitation—the invention being defined by the claims.

What is claimed is:

1. In a method for testing predetermined absorbency characteristics of a textile, paper or similar material sample including the steps of: (1) providing a liquid reservoir mounted on an electronic balance or load cell; (2) providing a vertically movable test plate for the material sample and a liquid conduit between the liquid reservoir and the test plate; and (3) analyzing liquid absorbency and/or desorbency with a computer operatively connected to the electronic balance or load cell; the improvement comprising:
(a) recording images of the liquid on the material sample with a camera mounted above the test plate and operatively connected to the computer; and
(b) analyzing the recorded images with the computer to make real time determinations of selected properties of liquid absorbency and/or desorbency of the textile material sample.

2. In a method for testing predetermined absorbency characteristics of a material sample according the claim 1 including providing a hollow test plate with a liquid conducting cylinder in the middle of the test plate for supporting the material sample thereon.

3. In a method for testing predetermined absorbency characteristics of a material sample according to claim 2 including providing a hoop element textile material sample holder adapted to fit onto the hollow test plate.

4. In a method for testing predetermined absorbency characteristics of a material sample according to claim 1 including testing a nonwoven fabric.

5. In a method for testing predetermined absorbency characteristics of a material sample according to claim 1 including maintaining a constant head pressure on the liquid by lowering the test plate as the liquid in the liquid reservoir decreases and calculating the orientation distribution function (ODF) of the recorded images.

6. In a method for testing predetermined absorbency characteristics of a textile material sample according to claim 5 including using a Fast Fourier Transform (FFT) to calculate the ODF of the recorded images.

7. In a method for testing predetermined absorbency characteristics of a material sample according to claim 1 including raising the test plate relative to the liquid reservoir to a selected vertical position to achieve a predetermined pressure and analyzing the recorded images to calculate desorbency characteristics of the material sample.

8. In a method for testing predetermined absorbency characteristics of a material sample according to claim 7 including calculating the orientation distribution function (ODF) of the recorded images.

9. In a method for testing predetermined absorbency characteristics of a material sample according to claim 1 including raising the test plate relative to the liquid reservoir to a selected vertical position and analyzing the recorded images to calculate selected pore size (volume) characteristics.

10. In a method for testing predetermined absorbency characteristics of a material sample according to claim 9 including successively raising the test plate to create pressure changes on the material sample and determining the pore volume distribution.

11. In an apparatus for testing absorbency characteristics of a textile, paper or similar material sample comprising: (1) a liquid reservoir mounted on an electronic balance or load cell; (2) a liquid supply system for supplying a plurality of test liquid samples from a storage chamber in the liquid reservoir to a test liquid chamber; (3) a vertically movable test plate and actuator assembly for mounting of the material sample thereon; (4) a liquid conduit extending from the test liquid chamber to the test plate; and (5) a computer operatively connected to the electronic balance or load cell; the improvement comprising:
(a) a video camera mounted above and at a predetermined distance from the test plate and adapted to be vertically movable therewith, the video camera being operatively connected to the computer; and
(b) a computer program for analyzing recorded images from the video camera to make real time calculations of selected liquid absorbency and/or desorbency characteristics of the material sample.

12. In an apparatus for testing absorbency characteristics of a material sample according to claim 11 wherein the test plate can be raised up to about 2.0 meters above the liquid reservoir.

13. In an apparatus for testing absorbency characteristics of a material sample according to claim 11 wherein the apparatus is adapted to measure absorption of the material sample by lowering the test plate as the liquid in the test liquid chamber of the reservoir decreases in order to maintain a constant head pressure, and to simultaneously calculate the orientation distribution function (ODF) of the recorded images.

14. In an apparatus for testing absorbency characteristics of a material sample according to claim 11 wherein the apparatus is adapted to measure desorption of the material sample by raising the test plate relative to the test liquid chamber to a predetermined height above the reservoir to achieve a desired pressure, and to simultaneously calculate the orientation distribution function (ODF) of the recorded images.

15. In an apparatus for testing absorbency characteristics of a material sample according to claim 11 wherein the apparatus can measure certain pore size characteristics by successively raising the test plate relative to the test liquid chamber of the reservoir to create pressure changes on the material sample, and simultaneously analyzing the recorded images to determine pore volume distribution.

16. In an apparatus for testing absorbency characteristics of a material sample according to claim 11 wherein the material sample is a nonwoven fabric.

17. In an apparatus for testing absorbency characteristics of a material sample according to claim 11 wherein the liquid is water or any other fluid.

18. In an apparatus for testing absorbency characteristics of a material sample according to claim 11 wherein the computer program for analyzing recorded images from the video camera resides in the computer operatively connected to the electronic balance or load cell and to the video camera.
